(19) United States
(12) Patent Application Publication
(10) Pub. No.: US 2008/0259590 A1
(43) Pub. Date: Oct. 23, 2008

(54) Button Arrangement for Colored Lighting Controller

(75) Inventor: Ay Ling De Goederen - Oei, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/097,528

(22) PCT Filed: Dec. 12, 2006
(86) PCT No.: PCT/IB2006/054757

§ 371 Date: Jun. 14, 2008

(30) Foreign Application Priority Data
Dec. 22, 2005 (EP) 05112816.3

(51) Int. Cl. F21V 33/00

(52) U.S. Cl. 362/85

(57) ABSTRACT

A user interface device (100) for controlling a light source (120) includes a central button (140) configured to change color of light emitted from the light source (120) when actuated by circumnavigating a color wheel; a saturation button (145, 150) configured to change saturation of the light when actuated; and a hue button (155, 160) configured to adjust hue of said light when actuated. The central, saturation and hue buttons may be discrete buttons or integrated into a single button (210). The user interface device (100) further includes a brightness button (110) located at a spaced distance from the central button (140) and is configured to change intensity of the light when actuated.

The present invention relates to the arrangement of control buttons on a lighting control panel for controlling the brightness, color, hue and saturation of a light source.

It is well known in the theatrical, industrial and commercial settings to employ colored lighting sources. The design and installation, as well as the daily control of such colored lighting sources, has traditionally been performed by relatively skilled and professional lighting technicians who have the technical skills and experience to operate complex control systems for controlling the brightness, color, hue and saturation characteristic of colored light. The control system for such colored lighting sources is normally relatively technical, using for example a screen based graphic user interface for which the operator needs to have considerable training and experience, as well as a technical knowledge of the characteristic of brightness, hue and saturation that influence the human perception of color.

As the use of colored lighting sources becomes increasingly common in the household and other consumer settings and commercial settings such as retail establishments, it would be desirable to provide user friendly and intuitive control arrangements by which relatively amateur and unskilled consumers or users would be enabled to achieve relatively sophisticated colored lighting environments. Such lighting systems, whether household or commercial, employ LED or other technologies that compose the desired color out of a combination of red (R), green (G), and blue (B) light sources such as LEDs.

The typical consumer/user is well experienced in controlling the parameter of brightness in typical non-colored household/commercial lighting where toggle on-off switches and also toggle, slideable or rotary dimming switches are used to control brightness. But, in the case of colored lighting, consumers may be limited to a rudimentary knowledge of the full color spectrum and the possibility to arrange colors in form of a circle, and have little or no understanding of the technicalities of saturation and hue. Thus there is a need for controls by which relatively untrained household user is able to intuitively control the parameters of brightness, color, hue and saturation even in the absence of a deep technical understanding of the principals of additive color blending of light.

Therefore, accordingly, an arrangement is provided for the control buttons upon the housing of a control device for controlling the color, saturation, hue and brightness of a colored light source. The button arrangement includes a central color control button that, when pressed, functions to cycle the color by navigating through the color circle and, when released, selects a chosen color. A top saturation control button and a bottom saturation control button are located respectively above and below the color control button. Pressing one of the saturation control buttons, e.g., the top button, increases the saturation of the color, and pressing the other saturation control button, e.g., the bottom button, decreases the saturation of the color. Right and left hue control buttons are located respectively to the right and left of the central color control button, and fine tune the color by adjusting the hue. Pressing one hue control adjusts the color in one direction around the R-G-B color wheel and pressing the other adjusts the color in the other direction around the R-G-B color wheel. A separate on-off brightness control button is located on the housing and spaced apart from the other buttons. The buttons are preferably marked with indicia that inform the user of the function of the particular buttons.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

These and other features, aspects, and advantages of the apparatus and methods of the present invention will become better understood from the following description, appended claims, and accompanying drawings where:

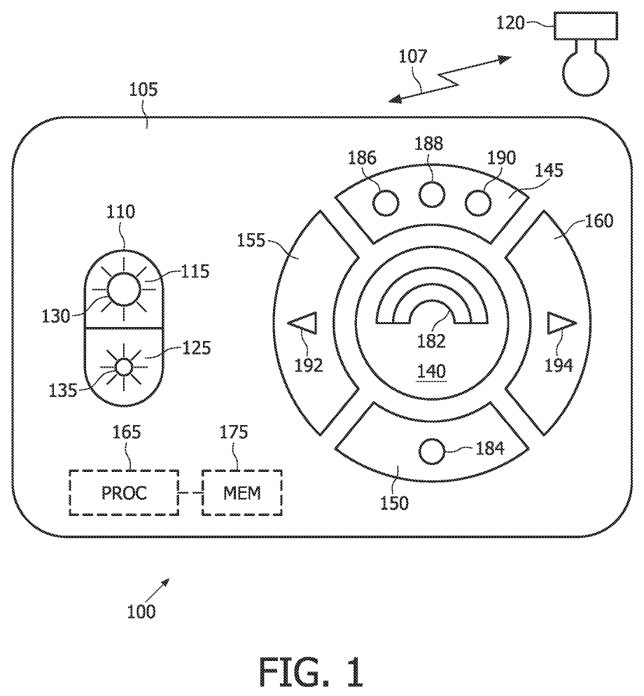

FIG. 1 is a plan view showing a user interface device for controlling a color lighting system; and

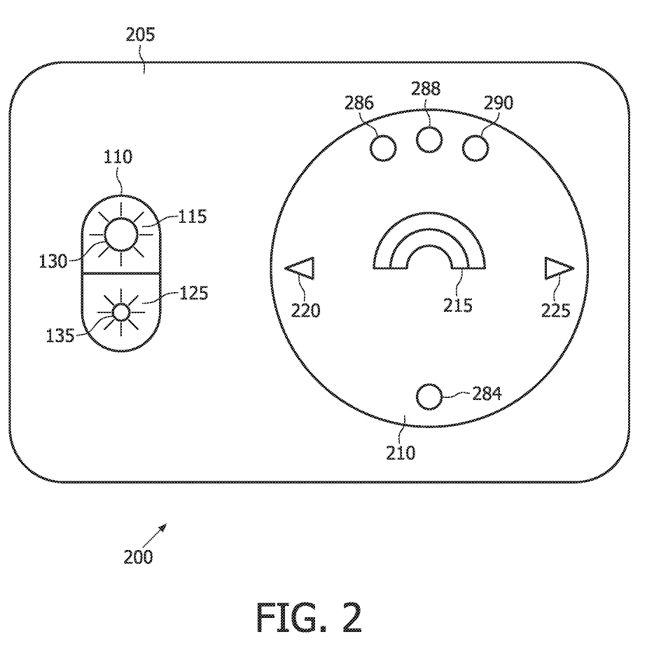

FIG. 2 is a plan view of a second embodiment of the user interface device.

The following description of certain exemplary embodiment(s) is merely exemplary in nature and is in no way intended to limit the invention, its application, or uses.

As shown in FIG. 1, a user interface device 100 includes a housing 105 which may be a molded plastic housing or any other type of housing. Illustratively, the user interface device 100 is a remote controller which may be any type of mobile device such as a stand alone remote controller for controlling lighting systems, or incorporated into other mobile or handheld devices, such as a universal remote control, a personal digital assistant (PDA), a mobile or cell phone and the like.

The housing 105 contains controls for communicating with at least one color lighting source, either by wire or by wireless transmission 107 using any type of wireless communication, such as radio frequency (RF), infrared, ultrasound, optical, laser and the like. Illustratively, wireless communication is via RF using various communication standards or protocols, such as Bluetooth™, Zigbee™, Zensys™ and the like.

Of course, the controller 100 as well as the controllable light source 120 has the necessary elements for wireless communication and control as is well known in the art, such as antennas, duplexers, transceivers, modulators, demodulators, mixers, filters, converters, processors, memory and the like. Further, the controllable light source(s) 120 has ballasts and electronic circuits for changing the output of each of the light sources in particular colors in such a way that attributes of the composed light emitted from the light source can be varied, such as varying intensity, hue, saturation and the like.

Any colored lighting technology may be used capable of being used with controllable light sources, such as solid state lighting (SSL), including light emitting diodes (LEDs), and the like. That is, the light source 120 may be any type of controllable light source, such as incandescent, halogen, fluorescent, high intensity discharge (HID), where light emitting diodes (LEDs) are particularly well suited for control to change the color and intensity of light emanating therefrom. The light sources may be configure in any type of fixtures to provide various types of illumination, such as accent lighting, general lighting, track lighting, table-top lighting, ceiling lighting, spot lighting, and the like. For simplicity, the discussion will be directed to the user interface device (UID) or remote controller 100 controlling a single light source. However, it should be understood that the discussion is equally applicable to controlling multiple light sources, group or groups of light sources and lighting system(s).

Returning to FIG. 1, a brightness control button 110 is mounted, e.g., on the left hand side of the housing 105 and includes an upper button 115 and a lower button 125. Pressing the upper button 115 will increase the brightness of the light. Pressing the lower button 125 will decrease the brightness of the light. Alternatively or in addition as desired, the brightness control button 110 is a switch, in which case long pressing on the upper button 115 will switch on the light and increase its brightness, and long pressing the lower button 125 will switch off the light or dim it until the light is eventually extinguished, if desired. The switching function of the brightness control button 110 may be in addition to the dimming function. Alternatively, a separate toggle on/off switch may be provided and the brightness control button 110 exclusively provides for changing the intensity of light emanating from the controllable light source 120.

Illustratively, the upper button 115 is imprinted with indicia in the form of a large circle 130 emitting light rays, and the lower button is imprinted with indicia in the form of a smaller circle 135 emitting rays. Of course, any other desired indicia may be provided, such as indicia suggesting increased and decreased brightness, including up and down arrows and the like, where the shape of the button 115, 125 may be any desired shape, such as an upper pointing arrow shape for the upper button 115, and a lower pointing arrow shape for the upper button 125.

The user interface device 100 also includes a color control button 140, a pair of saturation control buttons, including an upper saturation button 145 and a lower saturation button 150, and a pair of hue control buttons, including a left hue button 155 and a right hue button 160. Each button is associated with a switch and the switches are in turn connected with light control electronics or software.

Pressing the color control button 140 will control the light source 120 in a manner to cycle through the color circle while maintaining the saturation at a constant level, thus allowing the user to select a color. Pressing the color control button 140 initiates the cycling of the color by circumnavigating the color circle, and then the user releases the button to choose the preferred color. Of course, the color control button 140 as well as any of the buttons may be programmable to provide variant functions, including varying gradation of adjustments achieved by a single click. For example, instead of or in addition to continuous color change by pressing and keeping pressed the color control button 140 to provide continuously changing color until released, the user interface device 100 may be programmed, e.g., by the user, such that pressing the color control button 140 changes the color by relatively large discrete steps along the color circle, e.g., from red, to orange, to yellow, to green, to blue, to purple, where the size of the discrete steps also be programmable through a controller 165.

It should be noted that any other type of actuation or control means may be used instead of, or in addition to mechanical buttons, such as actuators capable of providing various signals for further processing and changing light characteristics for example, such as software buttons displayed on a touch screen of the interface device 100; touch button or areas associated with resistive or capacitive touch sensitive discs, actuators responsive to voice activation where the interface device 100 may have a voice recognition system to interpret and process voice commands. Of course, any desired graphical user interface may be used, particularly in the embodiment where the interface device 100 has a touch sensitive screen, where software button or desired interfaces may be displayed, selected and controlled by clicking on them, or on icons, or selecting various parameters from drop down menus using a pointing device, such as a pointer, a finger, a mouse or the like, for example.

As shown in FIG. 1, color indicia in the form of a rainbow 182 is imprinted on the color control button 140 to inform the user that this button controls color selection. Pressing the upper saturation control button 145 will change the saturation of the color in one direction and pressing the lower saturation control button 150 will change the saturation of the color in the other direction. As noted, various indicia may be provided on the buttons. Illustratively, the lower saturation control button 150 is imprinted with one small indicia circle 184, and the upper saturation control button 145 is imprinted with three small colored indicia circles 186, 188, 190, indicating for example that these buttons are associated with changing light color and/or hue. Such an arrangement of indicia circles may be reversed where colored indicia circles 186, 188, 190 are located on the lower saturation control button 150, and the single indicia circle 184 is located on the upper saturation control button 145.

Of course, the indicia circles may be configured to change colors. It should be understood that imprinted indicia does not merely refer mechanically or physically imprinted indicia. Rather, the indicia may be imprinted or provided by any suitable means. Illustratively, each of the indicia circles includes an LED (or LED RGB triplets to also provide white light) configured to provide changeable colored or white light.

The user will be intuitively informed and quick to learn the operation of the user interface device 100 because of the novel arrangement and shape and indicia of the various buttons. In the case of the color button 140, the button has a round shape that is reminiscent of the wheel shape of the color wheel, and also, the round shape is consistent with the fact that there is no start or end to going through the different colors. In addition, the rainbow 182 is readily recognizable as related to the choice of color. And by situating the color button 140 in the center of the display, the user is intuitively informed that this button is of primary importance and function, consistent with the fact that pressing this button will result in a cycle and change of colors around the color wheel rainbow of available colors.

The saturation buttons 145 and 150 are arranged vertically one above the other because there is a hierarchy of “more or less” for the characteristic of saturation, similar to the hierarchy associated with brightness or intensity, where the top saturation button 145 increases saturation (similar to the upper brightness button 115 increasing brightness), while the lower saturation button 150 decreases saturation (similar to the lower brightness button 135 decreasing brightness). Saturation refers in general to the dominance of hue in the color, and thus saturation is controlled by either the presence of more or less of the color. Less saturation means that the color will be more toward the grayscale and the color will dominate less.

The upper saturation button 145 may bear the three colored circles 186, 188, 190, such as a red circle 186, a green circle 188 and a blue circle 190, for example, to indicate that pressing the upper saturation button 145 will increase the degree of saturation, that is, give more color. The lower saturation button 150 may bear a white indicia circle 184 (or any other desired color which may be programmable by the user, similar to the programmability of other buttons and/or indicia) to indicate that pressing the button 150 will decrease the degree of saturation, that is, let the perceived color relax to more grayscale.

Of course, the user interface device 100 may have any different type of arrangement. For example, the upper saturation button 145 may bear a single indicia circle 184, while the lower saturation button 150 may bear three colored circles 186, 188, 190. The color of the top indicia circle 184 may be associated with the current or selected color of light emitted from the light source 120, while the three indicia circles 186, 188, 190 may provide indications of different saturations of the light color of the top indicia circle 184. For example, the lower left indicia circle 186 provides the minimum saturation, the lower right indicia circle 190 provides the maximum saturation, and the lower middle indicia circle 188 provides the current saturation (or the selected saturation to become the current saturation upon user activation) of light emitted from the light source 120. In the case where the buttons are software buttons graphically displayed on a display or screen of the interface device 100, instead of LED or LED triplets for example, then color of the indicia circles displayed on the screen may change under software control.

Unlike the parameter of saturation, where there is a hierarchy of “more or less” saturation, in the case of hue, there is only “difference”, in the sense that colors are not compared with each other in terms or “more or less”, but rather colors are only different. Accordingly, a vertical arrangement of the hue buttons 155, 160 does not add to intuitive use thereof, where illustratively, the hue control buttons 155, 160 are arranged in a horizontal position located to the right and left of the color button 140. By pressing the hue control buttons 155, 160, the user can obtain very fine differences in the color, as compared to the more gross selection of the initial color choice via pressing the color button 140. The left hue control button 155 is imprinted with indicia in the form of a left pointing arrow 192 and the right control button 160 is imprinted with a right pointing arrow 194. The location of these arrows just to the right and left of the central color control button 140 will further inform the user that the buttons 155 and 160 can be alternately pressed to achieve the hue that is desired. Pressing the right hue button 160 will change the hue in one direction along the color circle, and pressing the left hue button 155 will change the hue in the other direction. Accordingly, such a button arrangement provides an intuitive way of color control.

Referring to FIG. 2, a second embodiment of a user interface device 200 is shown having a housing 205. The brightness control button 110 is identical with that of the first embodiment of FIG. 1 and is designated by like reference numerals. The brightness control button 110 is mounted on the left hand side of the housing 205 and includes the upper button 115 and lower button 125 which operate in the same manner discussed in connection with FIG. 1, and may include similar indicia.

The user interface device 200 further has a single shuttle switch button 210 that is operated to choose the color, and adjust also the saturation and the hue, again similar to that described in connection with FIG. 1, the main difference being the hue and saturation are controlled by the single shuttle switch button 210, instead of separate switches or buttons. The single shuttle button 210 is similar to the shuttle buttons that are commonly employed on digital cameras and other modern digital electronic products, and, accordingly, its operation will be familiar to the average consumer.

The button 210 carries similar indicia as its counterpart in FIG. 1 to provide information to the user for intuitive light color control, including a rainbow 215 at its center, and other indicia at its perimeter. Illustratively, the rainbow 215 at its center signifies that pressing the center will cycle the color of the lighting source around the R-G-B color wheel, similar to pressing the color control button 140 shown in FIG. 1. Pressing the perimeters of the button 210, such as rocking the shuttle button 210 by pressing at its top and bottom will adjust the saturation to achieve either more grayscale or more color.

Various small circular indicia 284, 286, 288, 290 may also be included to provide information or to function in a similar manner as described in connection with the circular indicia 184, 186, 188, 190 shown in FIG. 1. For example, the left and right side edges of the shuttle button 210 are imprinted respectively with a left pointing arrow 220 and a right pointing arrow 225 to indicate that rocking the shuttle button 210 in these directions will adjust the hue of the color in the one direction or the other to achieve small gradations in the color selection.

The forgoing description of various embodiments is merely exemplary in nature and, thus, variations thereof are intended to be within the scope of the invention. For example, within the principle of providing a user interface device that is user friendly by intuitively informing the user as to its various control functions, it may be desirable to modify the device shown in the drawing somewhat by conducting consumer tests to discern the optimal arrangement and markings for the particular buttons. For example, the figures show particular arrangements of small circular indicia having different or changeable colors, at particular locations and particular number of circular indicia. However, consumer testing might indicate that consumers would normally intuit that other arrangements are more desirable, particularly as technology and consumer taste changes where other arrangements or indicia become more intuitive.

Thus, consumer testing could be conducted to test the consumer's intuitive understanding and interpretation of the markings imprinted on the buttons. For example, with regard to the saturation button for decreasing the saturation, it may be more informative to replace or rearrange the circular indicia 184, 186, 188, 190, or provide differently colored circular indicia, such as replacing the single small circular indicia 184, having a white color with three small circles colored white, gray, and black to indicate that pressing this button will adjust the color perception away from the colors and more toward the grayscale. And it may be preferable to have the color control button 140 be pressed multiple times by the user to have the color step further around the color with each press of the color control button in larger discrete steps, instead of toggling from red to green in smaller discrete steps, or changing from red to green in a continuous manner, for example.

Color control and programming or reprogramming the various buttons are suited to be carried out by a computer software program running on the controller 165, for example. Such software can of course be embodied in a computer-readable medium, such as an integrated chip, a peripheral device or memory 175 coupled to controller 165 which may also store other data and operating instruction of the controller 165, which may include a dedicated processor for performing in accordance with the present invention, or may be a general-purpose processor wherein only one of many functions operates for performing in accordance with the present invention.

The memory 175 may also include predetermined preset of particular light characterstic(s), including intensity, color, hue and saturation, which may be associated with particular light sources so that such a particular light source when activated produces light in accordance with its associated preset stored in the memory 175, for example. The controller or processor 165 may operate utilizing a program portion, multiple program segments, or may be a hardware device utilizing a dedicated or multi-purpose integrated circuit. Each of the above systems utilized for operating the user interface device and color control may be utilized in conjunction with further systems.

Finally, the above-discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) each of the disclosed elements may be comprised of hardware portions (e.g., discrete electronic circuitry), software portions (e.g., computer programming), or any combination thereof.

1. A user interface device (100) for controlling a light source (120), said user interface device (100) comprising:
a central button (140) configured to change color of light emitted from said light source (120);
a saturation button (145, 150) configured to change saturation of said light; and
a hue button (155, 160) configured to adjust hue of said light.

2. The user interface device (100) of claim 1, wherein said central button (140) changes said color by circumnavigating a color wheel.

3. The user interface device (100) of claim 1, wherein said saturation button has a first portion (145) and a second portion (150) that are located respectively above and below said central button (140) for increasing and decreasing said saturation, or decreasing and increasing said saturation, respectively.

4. The user interface device (100) of claim 1, wherein said hue button has a first part (155) and a second part (160) that are located respectively at right and left sides of said central button (140) for changing said hue.

5. The user interface device (100) of claim 1, further comprising a brightness button (110) configured to change intensity of said light.

6. The user interface device (100) of claim 5, wherein said brightness button (110) is located at a spaced distance from said central button (140).

7. The user interface device (100) of claim 1, wherein said central button (140), said saturation button (145, 150) and said hue button (155, 160) are one of discrete buttons or integrated into a single button (210).

8. The user interface device (100) of claim 6, wherein said central button (140), said saturation button (145, 150) and said hue button (155, 160) include different indicia.

9. The user interface device (100) of claim 8, wherein said indicia are indicative of functions of said central button (140), said saturation button (145, 150) and said hue button (155, 160).

10. The user interface device (100) of claim 1, wherein said central button (140) has a rainbow insignia to indicate color selection.

11. The user interface device (100) of claim 1, wherein said central button (140) is configured to provide gross selection of said color, and said hue button (155, 160) is configured to provide fine adjustment of said hue of said color.

12. The user interface device (100) of claim 1, further comprising indicia configured to have changeable appearance of at least one of color and hue.

13. The user interface device (100) of claim 1, further comprising indicia configured to have changeable appearance among at least one of white, gray and black to indicate changes of hue among more perceived color, less perceived color and grayscale.

14. The user interface device (100) of claim 1, wherein said central button (140), said saturation button (145, 150) and said hue button (155, 160) are software buttons on a screen of said user interface device (100).

15. The user interface device (100) of claim 14, wherein said screen includes a touch sensitive screen.

16. The user interface device (100) of claim 1, wherein at least one of said central button (140), said saturation button (145, 150) and said hue button (155, 160) are part of at least one of a resistive disc and a capacitive disc.

17. The user interface device (100) of claim 1, further comprising a controller (165) configured to provide programming functions of at least one of said central button (140), said saturation button (145, 150) and said hue button (155, 160).

18. The user interface device (100) of claim 1, further comprising a controller (165) configured to select said light source (120) from among a plurality of light sources.

19. The user interface device (100) of claim 1, further comprising a memory (175) configured to store presets of at least one of said color, said saturation, said hue and intensity of said light.
